(19) United States
(12) Patent Application Publication
(10) Pub. No.: US 2016/0327997 A1
(43) Pub. Date: Nov. 10, 2016

(54) Power Distributor of Computer Apparatus

(71) Applicant: Liang-Chun LU, Taoyuan County (TW)

(72) Inventor: Liang-Chun LU, Taoyuan County (TW)

(21) Appl. No.: 14/703,239

(22) Filed: May 4, 2015

(51) Int. Cl. G06F 1/26

(52) U.S. Cl. CPC G06F 1/26

(57) ABSTRACT

Provided is a power distributor of a computer apparatus. The power distributor includes a power supply unit for supplying power to the computer apparatus. The power distributor is characterized in that: the power supply unit is connected to the power distributor, and a computer allocator is connected to a first motherboard and a second motherboard, so as to supply power to the first motherboard and/or the second motherboard, respectively, wherein the power supply unit is on whenever one of the first motherboard and the second motherboard is on, wherein the power supply unit is off whenever both the first motherboard and the second motherboard are off. Accordingly, the power supply unit supplies power to and exercises control over the two motherboards.

### BACKGROUND OF THE INVENTION

1. Technical Field

The present invention relates to power distributors, and more particularly, to a power distributor provided for a computer apparatus and equipped with a power supply unit for supplying power to two motherboards.

2. Description of Related Art

Personal computers (PC) have been manufactured by mass production for decades to meet our need for work and entertainment; hence, PCs nowadays are not only in wide use but are also so popular as to be intertwined with our daily life.

Although doing word processing and listening to music with a mini PC involve different systems, these two activities entail performing different multiplex operations from a user perspective. However, a standalone operating system usually requires a standalone power supply unit. As a result, the prior art has room for improvement.

Hence, an issue to be addressed by the inventor of the present invention and related manufacturers is about overcoming the aforesaid drawbacks of the prior art.

### BRIEF SUMMARY OF THE INVENTION

In view of the aforesaid drawbacks of the prior art, the inventor of the present invention collected related data, considered and assessed the data comprehensively, conducted tests and corrections repeatedly according to the inventor's professional experience in the related industry, and eventually devised the present invention.

It is an objective of the present invention to provide a power distributor of a computer apparatus, comprising a power supply unit for supplying power to the computer apparatus, characterized in that: the power supply unit is connected to the power distributor, whereas a computer allocator is connected to a first motherboard and a second motherboard, so as to supply power to the first motherboard and/or the second motherboard, respectively, wherein the power supply unit is on whenever one of the first motherboard and the second motherboard is on, wherein the power supply unit is off whenever both the first motherboard and the second motherboard are off.

In an embodiment, the computer allocator is connected to a CPU of the first motherboard and a CPU of the second motherboard to supply power thereto.

Regarding the power distributor of the present invention, the computer allocator is connected to a first motherboard and a second motherboard, so as to supply power to the first motherboard and/or the second motherboard, respectively. Accordingly, a user only has to be equipped with a computer case in order to install two or more systems and performs personal multiplex operations on different operating platforms to meet different needs, for example, using an itx motherboard to carry out Web-based data transmission, and download, or maintenance, wherein the main system performs computation on a large amount of data.

Furthermore, the present invention effectively reduces power supply unit procurement expenditure, reduces the power consumed by electrical appliances, reduces the space otherwise occupied by the power supply unit inside the computer case, enhances the efficiency of heat convection inside the computer case, and reduces the temperature of the air inside the computer case.

### BRIEF DESCRIPTION OF THE SEVERAL VIEWS OF THE DRAWINGS

Objectives, features, and advantages of the present invention are hereunder illustrated with specific embodiments in conjunction with the accompanying drawings, in which:

FIG. 1 is a block diagram of a preferred embodiment of the present invention; and

FIG. 2 is a schematic view of the implementation of the preferred embodiment of the present invention.

### DETAILED DESCRIPTION OF THE EMBODIMENT OF THE INVENTION

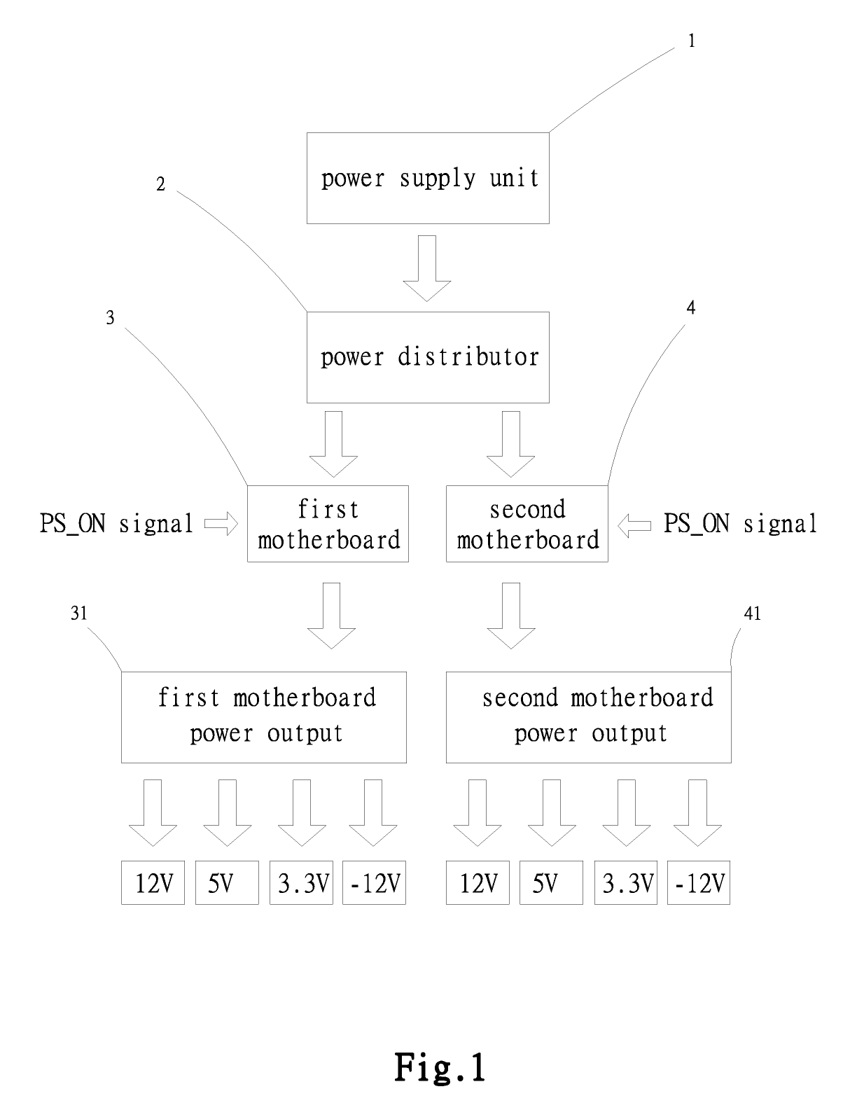

Referring to FIG. 1, according to the present invention, a power distributor of a computer apparatus comprises a power supply unit 1. The power supply unit 1 supplies power to the computer apparatus. Specifically speaking, the power supply unit 1 supplies power to components of the computer apparatus, such as a monitor, motherboard, CPU, main memory, PC interface, CD-ROM, hard disk drive, or input/output apparatus. According to the present invention, the power supply unit 1 is connected to a power distributor 2, whereas a computer allocator is connected to a first motherboard 3 and a second motherboard 4, so as to supply power to the first motherboard 3 and/or the second motherboard 4, respectively.

The first motherboard 3 has a first motherboard power output 31 for outputting a voltage, say, 12V, 5V, 3.3V and −12V, but the present invention is not limited thereto. The second motherboard 4 has a second motherboard power output 41 for outputting a voltage, say, 12V, 5V, 3.3V and −12V, but the present invention is not limited thereto.

The power supply unit 1 is on whenever one of the first motherboard 3 and the second motherboard 4 is on. The power supply unit 1 is off whenever both the first motherboard 3 and the second motherboard 4 are off. Hence, if one of the two motherboards, say, the first motherboard 3, is off, the power supply unit 1 still maintains the power supply to, and thus maintains the operation of, the other motherboard, i.e., the second motherboard 4. The power distributor 2 enables single said power supply unit 1 to control the power supply and power interruption of the first motherboard 3 or the second motherboard 4 independently.

The power supply status of the computer apparatus is indicated by signal PG and signal PS_ON#. Signal PG is controlled by a power source and indicates whether the power source is ready. Signal PS_ON# is controlled by the motherboards and indicate whether the computer apparatus is going to boot soon.

After being supplied with AC power, the power supply unit 1 outputs a 5Vsb voltage to the motherboards; meanwhile, portions of the circuits of the motherboards begin to operate and wait for the boot—a status known as the standby mode. As soon as the user turns on the switch of the computer apparatus, the motherboards convert signal PS_ON# into a low potential level. After receiving the low potential level, the power supply unit 1 starts and generates all the output voltages. In 0.1˜0.5 second after all the output voltages have been generated well, the power supply unit 1 converts signal PG into a high potential level and sends the high potential level to the motherboards to indicate that the power source is ready. Then, the motherboards start and operate.

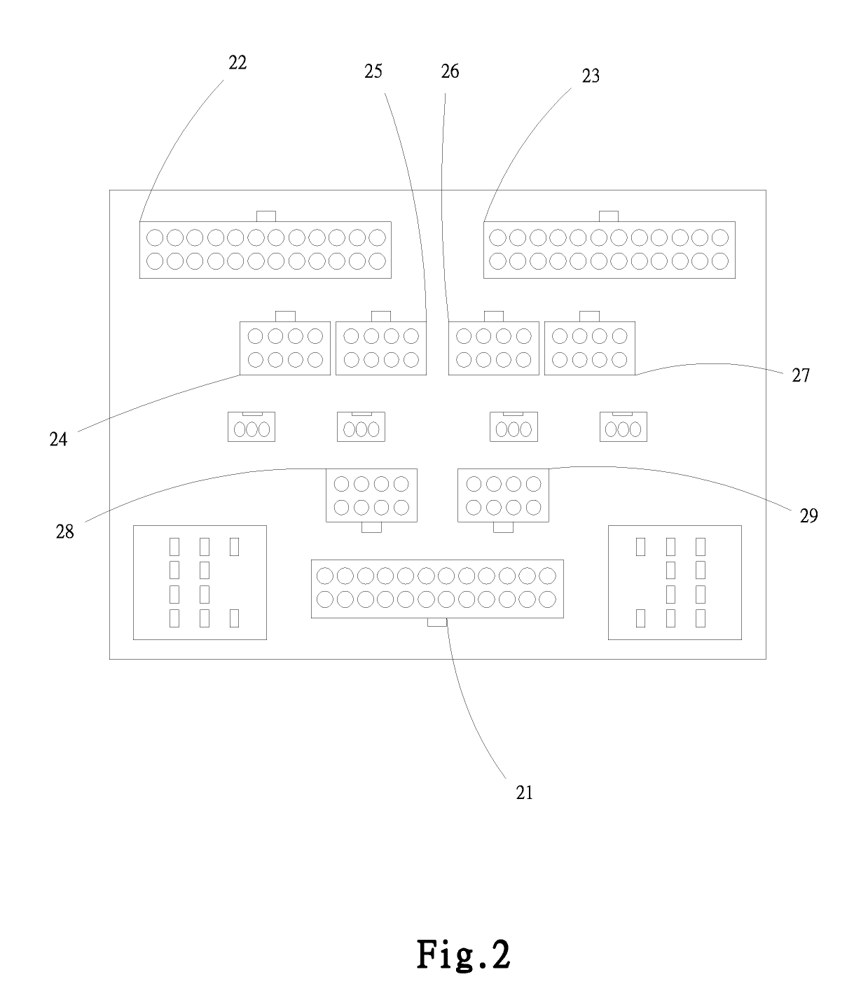

In reference to the aforesaid structures and components, the operation of the power distributor 2 of the present invention is described below. Referring to FIG. 1 and FIG. 2, the operation of the power distributor 2 of the present invention involves two control signals, namely signal 1 and signal 2. Signal 1 is indicative of a +5Vsb voltage directly output from the power supply unit 1 to two machines, i.e., the first motherboard 3 and the second motherboard 4, to maintain the standby mode. Signal 2 is signal PG separate from two tap wirings. The first motherboard 3 and the second motherboard 4 each have its own signal PG such that, whenever the first motherboard 3 and/or the second motherboard 4 are/is going to start or shut down, the first motherboard 3 and the second motherboard 4 send their respective signals to their respective power PG control systems and execute related operations independently. The main circuit of the power distributor 2 includes a monitoring circuit whereby the power supply unit 1 effectuates a shutdown as soon as it detects that both the two systems are off, thereby saving energy.

The power distributor 2 is connected to the CPU of the first motherboard 3 and the CPU of the second motherboard 4 so as to supply power thereto. Hence, the present invention is characterized in that: due to the sole connection to CPU+12V, only the power supply to the CPUs is placed under control to therefore exercise control over the computer apparatus in its entirety while the other component circuits are connected directly to the main power source (power supply unit 1).

FIG. 2 illustrates a specific embodiment of the power distributor 2 of the present invention. As shown in the diagram, the power distributor 2 comprises: 24PIN power input 21 for connecting with the power supply unit 1 and receiving power; 24PIN power output A (22) for outputting power to the first motherboard 3; 24PIN power output B (23) for outputting power to the second motherboard 4; (4+4) PIN CPU power output A1 (24), (4+4) PIN CPU power output A2 (25), (4+4) PIN CPU power output B1 (26) and (4+4) PIN CPU power output B2 (27) for outputting power to the CPU of the first motherboard 3 and the CPU of the second motherboard 4; and the (4+4) PIN CPU power input 1 (28) and (4+4) PIN CPU power input 2 (29) for receiving CPU power.

Referring to FIG. 1 and FIG. 2, compared with the prior art, the present invention has an advantage as follows: a power supply unit 1 for supplying power to two motherboards.

Although the present invention is disclosed above by preferred embodiments, the preferred embodiments are not restrictive of the claims of the present invention. All simple modifications and equivalent structural changes made to the embodiments in accordance with the specification and drawings of the present invention shall fall within the appended claims.

7 power supply unit
2 power distributor
21 24PIN power input
22 24PIN power output A
23 24PIN power output B
24 (4+4) PIN CPU power output A1
25 (4+4) PIN CPU power output A2
26 (4+4) PIN CPU power output B1
27 (4+4) PIN CPU power output B2
28 (4+4) PIN CPU power input 1
29 (4+4) PIN CPU power input 2
3 first motherboard
31 first motherboard power output
4 second motherboard
41 second motherboard power output

What is claimed is:

1. A power distributor of a computer apparatus, comprising a power supply unit for supplying power to the computer apparatus, characterized in that: the power supply unit is connected to the power distributor, whereas a computer allocator is connected to a first motherboard and a second motherboard, so as to supply power to the first motherboard and/or the second motherboard, respectively, wherein the power supply unit is on whenever one of the first motherboard and the second motherboard is on, wherein the power supply unit is off whenever both the first motherboard and the second motherboard are off.

2. The power distributor of claim 1, wherein the computer allocator is connected to a CPU of the first motherboard and a CPU of the second motherboard to supply power thereto.
